(19) United States
(12) Patent Application Publication
(10) Pub. No.: US 2005/0204610 A1
(43) Pub. Date: Sep. 22, 2005

(54) Livewell apparatus for a marine vessel

(75) Inventors: Michael M. Bogart, Delray Beach, FL (US); William Liptak, West Palm Beach, FL (US)

Correspondence Address: Michael M. Bogart, 8224 Desmond Dr, Boynton Beach, FL, 33437, US

(73) Assignee: K.M.B. Companies of Ohio, L.L.C.

(21) Appl. No.: 11/082,268

(22) Filed: Mar. 17, 2005

Related U.S. Application Data
(60) Provisional application No. 60/553,813, filed on Mar. 17, 2004.

(51) Int. Cl. A01K 97/20

(52) U.S. Cl. 43/55

(57) ABSTRACT

The present invention provides a livewell for a marine vessel for holding captive gamefish wherein the water temperature maintained in the livewell is maintained at a reduced temperature. The reduced water temperatures induces a state of reduced metabolism in the captive gamefish which prolongs the life of the gamefish in captivity. The water in the livewell is cooled by circulating water through a thermodynamic heat exchanger that transfers the heat to a refrigerant that is circulated through a conventional refrigeration cycle commonly found in air conditioning systems, freezers, and refrigerators. The refrigerant is compressed and circulated by a compressor powered by electricity from the marine vessel's batteries or electrical power system. A pair of pumps enable the water in the livewell to be circulated through the chiller assembly and to fill or empty the livewell as required.

This application claims priority to provisional application Ser. No. 60/553,813 filed on Mar. 17, 2004

### BACKGROUND OF THE INVENTION

1. Field of the Invention

The present invention relates generally to an apparatus for the temporary captive storage of live gamefish and other similar aquatic animals. More particularly, the present invention relates to an improved livewell apparatus for use in recreational or commercial fishing vessels utilizing a conventional refrigeration cycle to cool the water in the livewell.

2. Background Information

In marine vessels, it is typical to have a livewell for holding captive gamefish to hold the gamefish for relatively extended periods of time, such as up to twelve to sixteen hours covering an extended day's fishing trip. It is theorized that one of the principal causes of problems in maintaining captured fish alive is the excited nature of the fish when placed in a generally enclosed livewell or similar tank. As mentioned above, in this excited condition, fish tend to lose some portion of their scales and their natural slime secretions as well as to discharge bodily wastes and even to vomit the contents of their digestive tracts. All of this foreign matter in the water in a livewell poses a danger to the fish in that the foreign matter may become lodged in the fish's gills during normal breathing. Moreover, the excited nature of the fish significantly increases its metabolism causing it to utilize oxygen from the water at a significantly increased rate. Finally, it is known that fish are relatively sensitive to the temperature of the ambient body of water and, therefore, any difference in the temperature of the water in the livewell from that of the surrounding ambient body of water, particularly when the livewell water is elevated, may exacerbate the excited condition of the fish.

There have been attempts to design livewells with cooling systems that circulate water in the livewell that has been chilled to maintain the water temperature in the livewell below the temperature of the natural aquatic habitat of captured gamefish to induce a state of reduced metabolism to prolong the life of the captive gamefish. One such system can be found in U.S. Pat. No. 4,748,765 which provides a livewell for captive gamefish which contains water cooled by circulating the water through an auxiliary ice tank. However, a major drawback to such systems is the need to provide a sufficient quantity of ice to the auxiliary ice tank at the beginning of every fishing trip. In some instances, the supply of ice may not be sufficient to last the duration of the trip to maintain the temperature of the water in the livewell for the duration of the trip. The present invention provides a solution to this problem by providing a livewell that has the water temperature maintained at the reduced temperature by circulating water through a thermodynamic heat exchanger that transfers the heat to a refrigerant that is circulated through a conventional refrigeration cycle commonly found in air conditioning, freezers, and refrigerators. The refrigerant is compressed and circulated by a compressor powered by electricity from the marine vessel's batteries or electrical power system. Thus, the need for the auxiliary ice tank and ice is eliminated and the water in the livewell can be cooled continuously for an indefinite period.

### SUMMARY OF THE INVENTION

The present invention provides a livewell for a marine vessel for holding captive gamefish wherein the water temperature maintained in the livewell is maintained at a reduced temperature. The water is cooled by circulating water through a thermodynamic heat exchanger that transfers the heat to a refrigerant that is circulated through a conventional refrigeration cycle commonly found in air conditioning systems, freezers, and refrigerators. The refrigerant is compressed and circulated by a compressor powered by electricity from the marine vessel's batteries or electrical power system.

It is an object of the invention to provide a livewell for a marine vessel for holding captive gamefish wherein the water temperature maintained in the livewell is maintained at a reduced temperature.

It is another object of the invention to provide a livewell for a marine vessel for holding captive gamefish wherein the water temperature maintained in the livewell is maintained at a reduced temperature wherein the water is cooled by passing it through a thermodynamic heat exchanger that is provided cooling by a cooling system that includes a compressor powered by an electrical power source.

The foregoing and other objects of the present invention will be readily apparent from the following description and the attached drawings.

### BRIEF DESCRIPTION OF THE DRAWINGS

The invention will now be described, by way of example, with reference to the attached drawings, of which:

FIG. 1 is a cutaway perspective view of an improved livewell apparatus system installed in the hull of a marine vessel, according to the preferred embodiment of the present invention;

FIG. 2 is a perspective view of cooling system for the improved livewell apparatus shown in FIG. 1, according to the preferred embodiment of the present invention;

FIG. 3 is an exploded view of the cooling system shown in FIG. 2, according to the preferred embodiment of the present invention; and

FIG. 4 is a schematic diagram of the cooling system of FIG. 2 operatively connected to the livewell apparatus of FIG. 1; according to the preferred embodiment of the present invention.

### DETAILED DESCRIPTION OF THE INVENTION

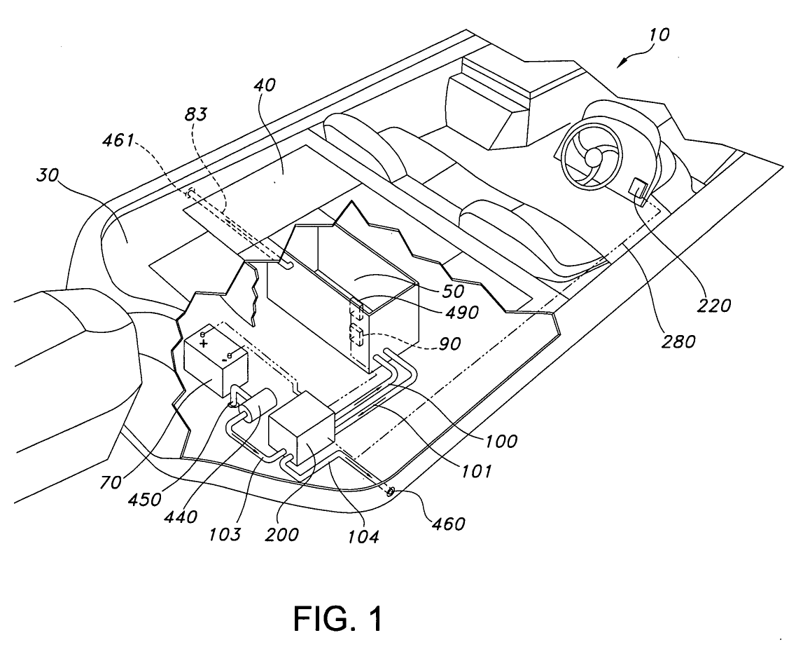

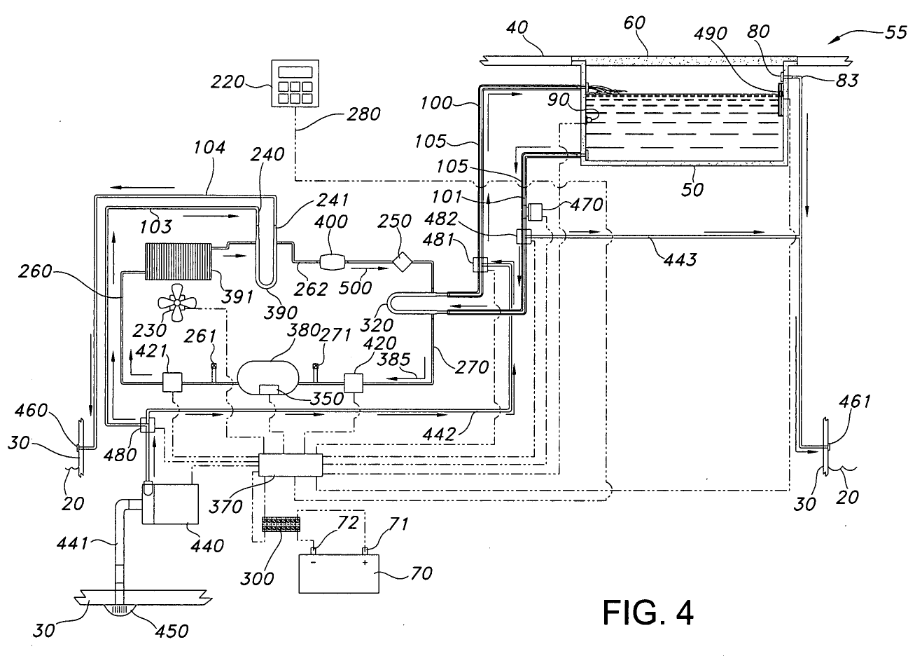

FIG. 1 is a perspective view of an improved livewell 50, according to the preferred embodiment of the present invention, shown mounted within the hull 30 of a conventional fishing-type recreational boat 10 and part of a livewell apparatus and control system 55 (FIG. 4). Such boats 10 include a hull 30 and an outer deck 40 horizontally mounted within the interior of hull 30 and extending transversely from one side of the hull 30 to the opposite side. Conventionally, fishing boats 10 of this type have an insulated tank, commonly referred to as a livewell 50, mounted beneath the outer deck 40 and accessible therethrough by a movable cover or lid 60 (FIG. 4). The livewell 50 is mounted flush below the deck 40 of the vessel and takes up very little space. Operatively connected to the livewell 50 is a chiller assembly 200 conveniently installed under the deck 40 in an out of the way equipment area, saving valuable deck space for other fishing and the like equipment. The chiller assembly 200 (described more fully hereinbelow) provides the cooling needed to cool the water in the livewell 50 to maintain the water temperature in the livewell 50 below the temperature of the natural aquatic habitat of captured gamefish. Alternately, in special circumstances, the water in the livewell 50 may need to be heated in which case chiller assembly 200 heats the water being provided to the livewell 50 until the desired temperature is reached. In this capacity, the chiller assembly 200 operates much like a heat pump wherein the refrigeration cycle is reversed. For convenience purposes, the usage of chiller assembly 200 will be maintained throughout the description although chiller assembly 200 may be used alternately to raise the temperature in the livewell 50.

A control module 220 including an on/off switch (not shown) is provided for energizing and de-energizing the chiller assembly 200 and selecting the mode of operation of livewell 50 connected thereto. A wire 280 connects control module 220 to a controller circuit board 370 (FIG. 4). The livewell 50 has a remote temperature sensing device 90 which senses the temperature of the water therein and sends a signal to the controller circuit board 370 (FIG. 4). The controller circuit board 370 (FIG. 4) controls chiller assembly 200 which either heats or cools the water passing therethrough. Water from livewell 50 is received by chiller assembly 200 by supply water piping 100 and returned to chiller 200 by return water piping 101. A thermodynamic exchanger 320 (FIG. 4) inside chiller assembly 200 removes or adds heat to the water flowing therethrough with a refrigerant that flows through a refrigerant loop 385 (FIG. 4) also located inside chiller assembly 200. The complete operation of chiller assembly 200 is described more fully hereinbelow.

Livewell 50 also includes a water level sensing device 490 which senses the level of the water in the livewell 50 and when the water gets to the desired level it sends a signal to the controller circuit board 370 (FIG. 4) to stop the flow of water so that the water does not overfill the livewell 50. In the event that livewell 50 is overfilled, an overflow inlet 80 (FIG. 4) is provided just above the water level sensing device 490 which further directs overflow water to the lake or ocean via an overflow piping 83 and overflow outlet 461 (FIG. 4). Regular maintenance to make sure this oveflow inlet 80 is not clogged is advisable.

The livewell 50 is fluidly connected to the chiller assembly 200 by means of a supply water line 100 and a return waterline 101 which circulates the water from the livewell 50 to the chiller assembly 200 to maintain the temperature of the water passing therethrough at the desired temperature. A circulating pump 470 (FIG. 4) is provided for this purpose. A battery 70 provides electrical power to circulating pump 470 (FIG. 4) for circulating the water through chiller assembly 200. Another pump 440 is provided for circulating water drawn from the lake or ocean 20 (FIG. 4) through a water strainer 450 (FIG. 4) and piping 441 (FIG. 4) into chiller assembly 200 to be used as a cooling medium to cool refrigerant circulating through the refrigerant loop 385 (FIG. 4). After passing through chiller assembly 200, this water is discharged overboard via a discharge piping 104 and a discharge outlet 460 to the lake or ocean 20 (FIG. 4). Battery 70 also provides electrical power for pump 470 (FIG. 4).

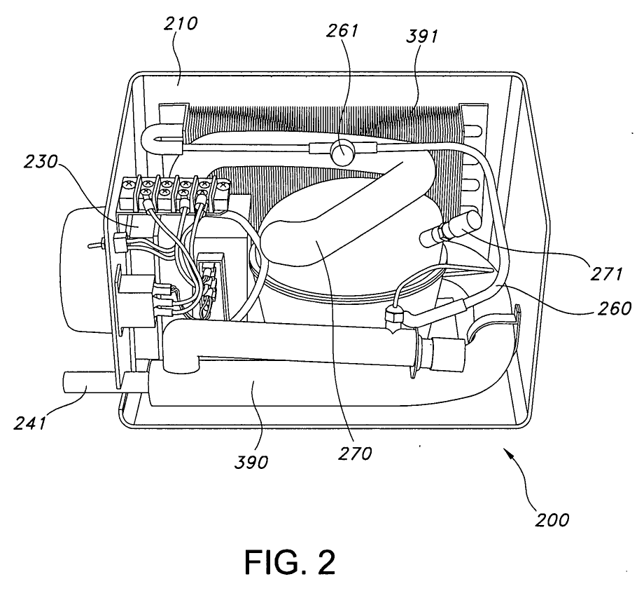

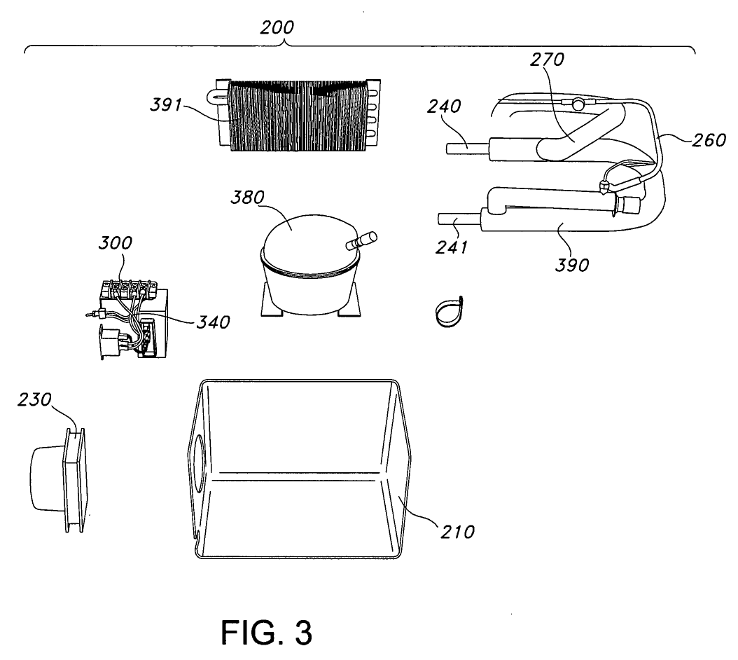

Referring now to FIGS. 2 and 3, shown is a cutaway perspective view and exploded perspective view of the chiller assembly 200, according to the preferred embodiment of the present invention. The chiller assembly 200 includes a compressor 380, heat exchangers 390 and 391, electrical bus 300, wiring harness 340, motor-fan assembly 230, enclosure 210, high pressure service port 261, low pressure service port 271, water outlet 241, and water inlet 240. The water supply piping 100 (FIG. 1) is fluidly connected to water inlet 240 and the water return piping 101 (FIG. 1) is fluidly connected to water outlet 241.

Referring now to FIG. 4, shown is a schematic diagram of the chiller assembly 200 of FIGS. 2 and 3 operatively connected to the livewell apparatus 50 of FIG. 1, according to the preferred embodiment of the present invention.

The livewell apparatus 50 is operatively connected to chiller assembly 200 via water supply piping 100 and water return piping 101. In operation, when a desired water temperature is selected at control module 220, refrigerant such as R-22 or R-134 is circulated through a refrigerant loop 385 in the direction of arrow 500. Water circulating from livewell 50 is passed through a chiller plate/evaporator 320 to remove heat from the circulated water. As the heat is absorbed by the refrigerant through chiller plate/evaporator 320 the refrigerant begins to change in phase from liquid to a vapor. The low pressure vapor refrigerant moves back to the compressor 380. The compressor 380 is controlled by a relay 350 activated upon signal from controller circuit board 370.

The low pressure vapor refrigerant is compressed to a high pressure and discharged out of the compressor 380. The refrigerant flows to a first heat exchanger 391 which removes some heat to begin a phase change from a vapor to a liquid. A fan 230 blows air across heat exchanger 391 to remove absorbed heat from the refrigerant. Fan 230 is switched on upon signal from controller circuit board 370. The refrigerant then flows to a second heat exchanger 390 which gives up absorbed heat to water circulating through the second heat exchanger 390. The water circulated is drawn from the lake or ocean 20 from a water strainer 450 and circulated through the second heat exchanger 390 before being discharged overboard through a piping 104 and overboard discharge 460 passing through hull 30. The refrigerant then flows through a filter drier 400 and then a thermal expansion valve 250 which changes the phase of the refrigerant to a low pressure liquid. As the refrigerant again flows through the chiller plate/evaporator 320 and absorbs heat from the water circulated from the livewell 50, it again begins to change phase from a liquid to vapor. This cycle is repeated until the temperature of the water in the livewell is reduce to the desired selected temperature and compressor 380 and pump 440 are switched off by controller circuit board 370.

The battery 70 provides electrical power to the aforementioned electrical components via a positive battery wire 71 and a negative battery wire 72 the battery could be a 12 volt D.C. battery or other voltage battery or the battery could be replaced by some other onboard electrical power source and connected to an electrical power bus 300. Electrical power is further distributed to the electrical components via a wiring harness 340 (FIG. 3). These are all conveniently installed under the deck in an out of the way equipment area, saving valuable deck space for fishing and other equipment. The controller circuit board 370 is connected to the remotely located control module 220 wherein the operator can select the desired operating mode and temperature to be maintained in the livewell 50 by the chiller assembly 200 and report the current temperature and desired temperature of the water in the livewell 50 to the operator. The controller circuit board 370 also controls circulating pump 440 for circulating water drawn from the lake or ocean through the chiller assembly 200 for providing cooling water for the second heat exchanger 390 in chiller assembly 200.

There are three solenoid valves 480, 481 and 482 for selectively isolating and fluidly connecting the piping for the cooling water for the first heat exchanger 390 and the livewell 50 to chiller assembly 200 or the overboard discharge piping 83 as required to perform the various functions when the operator selects one of several operating modes at control module 220. Each of the three solenoid valves 480, 481 and 482 valves are operated upon signal from controller circuit board 370. Specifically, solenoid valve 480 is operated to connect piping 441 from the water strainer 450 to piping 103 connecting the water inlet 240 of chiller assembly so that cooling water flows through the second heat exchanger 390 for cooling purposes. The water then flows through water outlet 241 to piping 104 for discharge via overboard discharge 460. Likewise, solenoid valves 481 and 482 are operated so that livewell 50 water flows through evaporator 320 to be cooled before being returned via piping 100 to livewell 50. Alternately, solenoid valve 480 may remain closed so that no water flows through the second heat exchanger 390 so that no cooling water is provided. Water is then free to circulate through to chiller assembly 200 via piping 100 and 101 but no cooling is provided to the circulating water.

In another mode, solenoid valve 480 is operated to connect piping 441 to piping 442 which is connected to piping 100 so that livewell 50 can be filled with water from the lake or ocean 20. In this mode, solenoid valve 481 is also operated so that piping 442 is fluidly connected to piping 100. The pump 440 is energized and will remain energized until water in the livewell 50 reaches the level of the water level sensing device 490. The overflow inlet 80 and overflow piping 83 are located just above the water level sensing device 490 to prevent overfilling of the livewell 50 above the level of the overflow piping 83. Regular maintenance is advised to make sure the inlet 80 and the overflow piping 83 is not clogged. Once livewell 50 is filled with water it is ready for operation.

After prolonged use of livewell 50, it may be desirable to empty the livewell 50 so it can be cleaned or maintained and fresh water can be replaced in livewell 50. The emptying of livewell 50 can be performed by using the remote control module 220. A signal from remote control module 220 operates each of solenoid valves 480 and 481 so that the direction of the flow of water from the livewell 50 is directed through the return water line 101 the recirculating pump 470 the solenoid 482 to the overboard discharge piping 443 and overboard discharge 461 which is mounted in and through the hull 30 of the vessel 10.

The chiller assembly 200 includes a compressor 380 to compress the refrigerant gas contained in the refrigerant loop 385. The refrigerant loop 385 has a high pressure service port 261 and a low pressure service port 271 to service the chiller assembly 200. The refrigerant through a high pressure switch 421 which can be optionally installed for the safety of the system to shut down should the pressure reach a set high level, as well as a low pressure switch 420 installed for the safety of the system to shut down should the pressure reach a set low level. In an alternate embodiment of the invention, the chiller assembly 200 can operate with either a water cooled condensing coil 390 or an air cooled condensing coil 391 as desired for the particular application and specifications for the system and desired by the user of the system.

While there have been shown and described herein preferred embodiments of the present invention, it should be apparent to persons skilled in the art that numerous modifications may be therein without departing from the true spirit and scope of the invention. Accordingly, it is intended by the appended claims to cover all such modifications which come within the spirit and scope of this invention.

1. A livewell apparatus for temporarily holding captive gamefish in water maintained at a temperature below that of the natural aquatic habitat of the captured gamefish, comprising:
a livewell having an interior volume for storing a quantity of water and captured gamefish; and
a chiller assembly for maintaining the temperature of the water below the temperature of the water of the aquatic habitat of the captured gamefish;
wherein the chiller assembly is comprised of a refrigerant cycle utilized to absorb heat from quantity of water the captured gamefish are temporarily held captive in.
